(19) United States
(12) Patent Application Publication
(10) Pub. No.: US 2007/0100694 A1
(43) Pub. Date: May 3, 2007

(54) Method and System for Encouraging Reuse and Recycling of Shopping Bags

(76) Inventor: Constance Lynn Kopps, Livermore, CA (US)

Correspondence Address: GODFREY & KAHN S.C., 780 NORTH WATER STREET, MILWAUKEE, WI, 53202, US

(21) Appl. No.: 11/550,397

(22) Filed: Oct. 17, 2006

Related U.S. Application Data
(60) Provisional application No. 60/727,286, filed on Oct. 17, 2005.

(51) Int. Cl. G06Q 30/00

(52) U.S. Cl. 705/14

(57) ABSTRACT

A method of encouraging the reuse or shopping bags by the inclusion of a tracking symbol on the shopping bag and recording when the shopping bag is reused to carry away purchased items from a store. Rewards may be provided based on if and/or the number of times that the shopping bag is reused. Rewards may also be provided to encourage recycling of the shopping bag. A system for encouraging the reuse or recycling of shopping bags.

### CROSS-REFERENCE TO RELATED APPLICATION

The present application claims benefit of the earlier filed provisional application Ser. No. 60/727,286, filed on Oct. 17, 2005, the disclosure of which is incorporated herein by reference.

### FIELD OF THE DISCLOSURE

The present disclosure relates generally to shopping bags and methods and systems to encourage reuse and recycling of shopping bags.

### BACKGROUND

In the many stores in the United States and in other countries, it is common for shoppers to be given plastic or paper shopping bags to carry their purchases home. It is also common that these shopping bags are single use items which are discarded and not reused by the shoppers. However, often these shopping bags may not be worn or damaged beyond use after only a single trip form the store to home. This may be demonstrated by the number of additional uses that people have made of these once-used shopping bags over time.

However, a great majority of these once-used and not-worn-out shopping bags are simply discarded. These bags then enter the common solid waste stream and may ultimately end up in landfills or other long term solid waste disposal sites. Shoppers are conventionally not encouraged, either through negative incentives (directly increasing cost to the shopper for every bag provided by the store) or positive incentives, to reuse or recycle used shopping bags. While negative incentives have been tried in the United States and may be conventional in other countries, these negative incentives have not been particularly effective in many countries. General rewards for recycling of shopping bags have not been pushed by many merchants as this does not provide a great incentive to customers to return to a particular store.

It is desirable to provide a positive incentive structure to encourage the reuse of shopping bags by a store that may also benefit the store by encouraging return visits by a customer.

### SUMMARY

The present disclosure relates generally to a method of encouraging reuse of shopping bags and more specifically relates to recording a tracking symbol associated with a shopping and rewarding the person reusing the shopping bag. The present disclosure further relates to a system for encouraging reuse of shopping bags.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of a shopping bag according to the present disclosure with a tracking symbol.

FIG. 2 is a view of an alternative embodiment of a tracking symbol for a shopping bag according to the present disclosure.

FIG. 3 is a view of a second alternative embodiment of a tracking symbol according to the present disclosure.

FIG. 4 is a perspective view of an alternative embodiment of a shopping bag according to the present disclosure.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

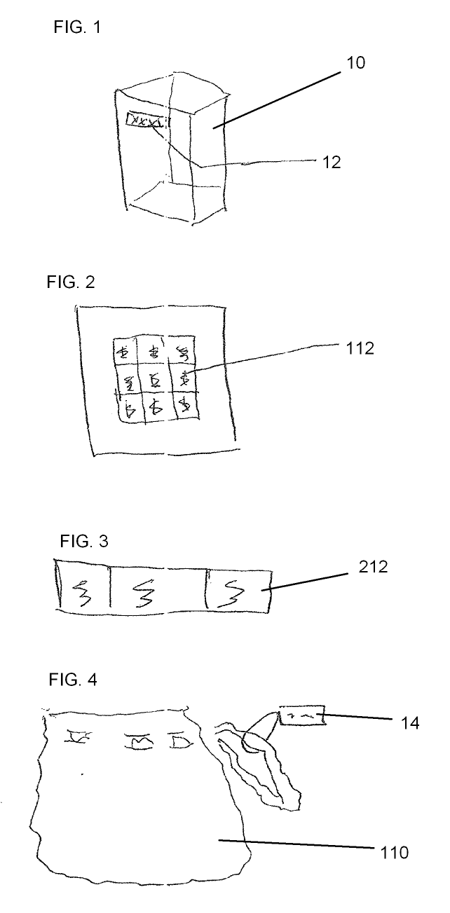

FIG. 1 illustrates a shopping bag 10 with a tracking symbol 12 affixed, attached, printed or otherwise associated with the shopping bag. Shopping bag 10 may be made of any number of suitable materials which may ordinarily be usable for at least an initial use and one subsequent use. Examples of suitable materials might be but are not limited to paper, plastic, non-woven materials and woven materials. Non-limiting examples of non-woven materials may include cellulosic or other suitable, durable non-woven materials, such as Tyvec™. Non-limiting examples of woven materials might be cotton or polyester canvas, nylon. or other similar materials.

Tracking symbol 12 provides a way for a store or organization to track when shopping bag 10 was first given to a person and when shopping bag 10 is used by a person to carry away purchased items from a store. In a single store example, a person may be given shopping bag 10 when making a purchase at the store so that the person can carry away the purchased item(s) from the store. When shopping bag 10 is given to a person, the tracking symbol on the bag is recorded. When shopping bag 10 is brought back to the store and reused to carry away purchased items a subsequent time, the person using the bag may be given a reward for the reuse. One of the goals of providing a reward for reuse of shopping bag 10 is to encourage reuse of shopping bag 10. Other benefits may also accrue to the store, such as encouraging or rewarding loyalty on the part of customers.

Tracking symbol 12 may be a unique symbol associated with shopping bag 10, or a plurality of shopping bags 10 may include a common tracking symbol associated with a particular store or group that initially provided the bag. With a unique tracking symbol 12 on each shopping bag 10, the number of times the bag is reused can be tracked and variable rewards may be provided based on the number of times the bag is reused. Further, the unique tracking symbol 12 may be associated with a particular person (such as, for example, the person initially receiving the bag) and that person could be rewarded directly when the bag is used a certain number of times.

A chain of stores or a plurality of associated stores might agree to track and provide incentives for reuse of shopping bag 10 at any of the participating stores.

Common tracking symbols 12 on a plurality of shopping bags 10 may allow a common incentive or reward to be provided whenever the bag is used. An example of this might be a charitable organization selling or giving away a shopping bag which permits the person using the bag to receive a discount or other reward at a participating store. Or a commonly marked shopping bag 10 could be provided by every store in a shopping mall and multiple uses of the bag at any store in the mall would be rewarded.

Alternatively, tracking symbol 12 might be associated with specific items within a store and the person reusing the bag may match the tracking symbol with shelf or product markings to see which products the reward is associated with. This might allow a particular supplier of the store to participate in a targeted incentive program with products provided by the supplier. Shopping bag 10 might also be marked with an advertisement or logo for that supplier or may be marked with a logo for the store providing the bag.

While it is preferable that shopping bag 10 be made of a durable material that may be reused a plurality of times, shopping bag 10 may be made of a less durable material, such as conventional shopping paper or plastic bags. While these bags may be suitable for one or a small number of uses, tracking symbol 12 may be used to track and reward appropriate recycling of these bags when they are beyond use. When a person returns an unusable shopping bag 10 to a store which will properly recycle the bag, the tracking symbol can be recorded and the person returning the bag for recycling may be rewarded. Even if conventional bags are only reused once or a few number of times, it is still desirable to reward such reuse and also to reward the proper recycling of the bags.

Alternatively, tracking symbols 112, shown in FIG. 2, may be used as a form of a game piece or game board. An example of this might be a bingo game. For this example, a person might be given a shopping bag with a tracking symbol 112 in the form of a bingo card and each time the person reuses the bag, the person is given a game token to match with the card in symbol 112. When the person acquires tokens is a winning configuration, the person may receive a reward.

The game concept might be reversed, using a tracking symbol 212 such as shown in FIG. 3. In this embodiment, shopping bag 10 might include one or more tokens to match against a bingo card at the store where the bag is being reused. If the person's shopping bag or bags 10 include tokens forming a winning configuration on the store's game card, the person receives a reward.

The above examples have utilized symbols on shopping bag 10, such as may be printed, embossed, screened, or otherwise been affixed to the body of the bag itself. Alternatively, a shopping 110, such as shown in FIG. 4, may include a tag or other item on which the tracking symbol 12, 112, or 212 may appear. Also, while all of the above examples of tracking symbols are visually identifiable, it is anticipated that any of the tracking symbols could be in the form of machine readable symbols or items. Examples of these machine readable items may include, but are not limited to, bar codes or RFID (radio-frequency identifier) elements.

It is also anticipated that escalating levels of rewards may be provided on a periodic basis or each time a shopping bag 10 is reused a certain number of times, such as every fifth use of the bag. Alternatively, differently schemes for randomly rewarding reuse may be implemented, such as added rewards for a randomly selected person reusing a bag, or added rewards for every one hundredth person reusing a bag. If the tracking symbol on shopping bag 10 is uniquely identifiable, then a particular shopping bag identifier might be selected to receive an added reward the next time that shopping bag is used. Alternatively, if several merchants or stores are cooperating in providing shopping bags 10, the unique identifier can be used to show how many of the different participating merchants the bag has been used at. An added reward can be provided when the bag has been reused at all or a specific number of the participating stores.

It is also anticipated that shopping bags according to the present disclosure could be incorporated into a government sponsored lottery. As a non-limiting example, a person could be provided with a free or reduced cost entry into the lottery based on a certain number of reuses of a shopping bag 10. In this way, the lottery could be used to provide a government sponsored incentive for increasing recycling and encouraging waste reduction.

While the system and method hereinbefore described is effectively adapted to address the desires described in the Background, it is understood that the present disclosure is not intended to be limited to the specific examples or embodiments set forth above. Rather, it is to be taken as including all reasonable equivalents to the subject matter of the claims appended to this disclosure.

What is claimed is:

1. A method of encouraging reuse of shopping bags, the method including:
providing a shopping bag with a unique tracking symbol attached to the shopping bag;
giving a person the shopping bag and recording the unique tracking symbol of the bag;
recording any time that the shopping bag is brought to a participating store and is used to carry away any items purchased;
when the bag has been used a number of times, giving the person using the bag a reward.

2. The method of claim 1, wherein the shopping bag is made of a durable washable material.

3. The method of claim 2, wherein the shopping bag is made of a woven material.

4. The method of claim 2, wherein the shopping bag is made of a non-woven material.

5. The method of claim 1, wherein the tracking symbol on the bag is a unique numerical identifier.

6. The method of claim 1, wherein the tracking symbol on the bag is a barcode.

7. The method of claim 1, wherein the tracking symbol is embroidered on the bag.

8. The method of claim 1, wherein the tracking symbol is printed on the bag.

9. The method of claim 1, wherein the tracking symbol is embossed on the shopping bag.

10. The method of claim 1, wherein the person using the shopping bag when the reward is given receives a token for use in a game with each use of the shopping bag.

11. The method of claim 1, wherein the tracking symbol on the shopping bag is a game token and the shopping bag must be used to carry away purchased items for the person using the bag to use the token in a game with which the token is associated.

12. The method of claim 1, wherein the tracking symbol is related to special pricing offers on merchandise at the store that can only be claimed by a person using the bag to carry away purchased items.

13. The method of claim 1, wherein the tracking symbol can be read remotely when the shopping bag is used to carry away purchased items.

14. The method of claim 1, wherein the person receives the shopping bag at a first store and is only rewarded for use of the shopping bag at the first store.

15. The method of claim 1, wherein the person receives the shopping bag at a first store and is rewarded for using the shopping bag at a plurality of stores associated with the first store.

16. The method of claim 1, wherein the person receives the shopping bag from an organization and receives a reward for using the shopping bag at a plurality of stores associated with the organization.

17. The method of claim 1, further comprising giving a reward to a person returning the shopping bag to a participating store for recycling after the bag is no longer usable to carry away purchased items.

18. A system for encouraging the reuse of a shopping bag, the system comprising:
a shopping bag made of a material suitable for a plurality of uses to carry away purchased items from a store, the shopping bag including a tracking symbol;
means for recording the tracking symbol of the shopping bag when the bag is initially used to carry away purchased items from a store;
means for recording the tracking symbol of the shopping bag when the shopping bag is reused to carry away purchased items from a store; and,
means for providing a reward to a person reusing the shopping bag to carry away purchased items from a store.

19. The system of claim 19, wherein the means for providing a reward provides a discount on items purchased at the store when the shopping bag is reused.

20. The system of claim 19, wherein the means for providing a reward provides a game token when the shopping bag is reused.
